(19) United States
(12) Patent Application Publication
(10) Pub. No.: US 2024/0370310 A1
(43) Pub. Date: Nov. 7, 2024

(54) RESOURCE SHARING IN AN ORCHESTRATED ENVIRONMENT

(71) Applicant: SIEMENS AKTIENGESELLSCHAFT, München (DE)

(72) Inventors: Christian Knierim, München (DE); Christian Peter Feist, München (DE)

(21) Appl. No.: 18/686,945

(22) PCT Filed: Aug. 16, 2022
(86) PCT No.: PCT/EP2022/072826

§ 371 Date: Feb. 27, 2024

(30) Foreign Application Priority Data
Aug. 30, 2021 (EP) 21193712.3

(51) Int. Cl. G06F 9/50

(52) U.S. Cl. CPC G06F 9/5083; G06F 9/505; G06F 9/5077

(57) ABSTRACT

A method and assembly for resource sharing in an orchestrated environment is provided including a first cluster and a second cluster, wherein each cluster automatically managing a container instance on at least one node of the clusters, the instance being designed to: receive a request including a provisioning policy; determine a first utilization status of first nodes of the first cluster; determine a second utilization status of second nodes; select a target node from one of the first and second according to the provisioning policy and according to the first utilization status and the second utilization status via the first orchestration unit; and start the container instance on the target node using the second orchestration unit, if the selected target node is a second node.

### CROSS-REFERENCE TO RELATED APPLICATIONS

This application claims priority to PCT Application No. PCT/EP2022/072826, having a filing date of Aug. 16, 2022, which claims priority to EP application Ser. No. 21/193,712.3, having a filing date of Aug. 30, 2021, the entire contents both of which are hereby incorporated by reference.

### FIELD OF TECHNOLOGY

The following relates to a method for resource sharing in an orchestrated environment having a first cluster and at least a second cluster, in which each cluster has at least one node for executing at least one container instance and an orchestration unit for automatically managing the container instances on the at least one node of the cluster.

### BACKGROUND

Container virtualization is a method in which multiple instances of an operating system can use an operating system kernel of a guest computer in isolation from one another. Software containers, hereafter referred to as containers for short, thus represent a lightweight type of virtualization of a runtime environment on a guest computer, also termed a host system, and encapsulate an application operated in a container from the underlying host system. Applications are now implemented in many sectors such as industrial automation and process control, but also for applications in transport systems or vehicles using containers.

In order to start a container on the host system, a container image is required which, in addition to the application software itself, also contains the binaries and libraries required for the application software. A container instance is created on the host system from the container image and executed in the runtime environment. If required, for example when the application is launched more frequently by users, additional container instances can be created and executed from the same container image on the same or a different host system.

Conventionally, container instances are operated using a runtime environment such as “Docker” on the host system, which may also be configured as virtualized hardware resources. To provide highly available container instances or to scale their load, containers are distributed across multiple organizationally or geographically distributed resources using an orchestration solution such as Kubernetes. For this purpose, a central orchestrator manages multiple devices, machines or other resources, commonly referred to as nodes, on which an orchestration front-end component such as “Kubelet” is operated and receives commands from an orchestration back-end component located on the central orchestrator and implements them on the container runtime environment.

US 2021/019194 A1 describes a multi-cloud service platform which orchestrates microservice containers of a service-mesh application in a multi-cloud environment. The multi-cloud service platform divides the application into multiple microservice containers, identifies each microservice container with control information, and performs actions to execute each of the microservice containers. The multi-cloud service platform can be part of a specific physical network or run as a SW suite on a cloud network. The microservices are controlled by an orchestrator and are executed by containers in nodes. A telemetry hub of the orchestrator collects their resources. A management layer of the multi-cloud service platform comprises a central resource counter that collects all computing resources to run the application and microservice containers. The resource counter obtains the counter values in particular from the telemetry hub, which collects this information from the physical hosts or virtual machines running the microservice containers.

US 2021/014113 A1 describes a device and method for orchestrated execution of services in a network of orchestrators of an edge-cloud computing environment. The device comprises a remote orchestrator which selects resources and orchestrates the execution of the service using the selected resources, and an orchestration manager which manages the individual orchestrators based on information from an interface to the orchestrators.

In a cluster consisting of orchestrators and nodes, unused hardware resources are usually available, which are held in reserve to absorb possible load peaks of an application, for example by scaling up container instances. In most cases, however, these clusters hold surplus and unused resources in reserve without them actually being requested. Due to the 1:1 allocation of nodes to an orchestrator, it is not possible for other orchestrators to share the use of these temporarily available resources of another cluster.

### SUMMARY

An aspect relates to distributing available resources across multiple orchestrators and use them simultaneously, while ensuring that the resources directly assigned to the orchestrator are available for the actual core tasks if needed.

According to a first aspect, embodiments of the invention relate to a method for resource sharing in an orchestrated environment with a first cluster and at least a second cluster, in which each cluster has at least one node for executing at least one container instance and an orchestration unit for automatically managing the container instances on the at least one node of the cluster, comprising
receiving a request to start the container instance, comprising a provisioning policy in a first orchestration unit of the first cluster,
determining a first utilization status of the first nodes of the first cluster for the purpose of providing the container instance by the first orchestration unit of the first cluster,
determining a second utilization status of the second nodes of the at least one second cluster by an exchange of load information between the first orchestration unit and a second orchestration unit of the at least one second cluster,
selecting a target node from one of the first and second nodes according to the provisioning policy and according to the first utilization status and the second utilization status by the first orchestration unit, and
starting the container instance on the target node by the second orchestration unit, if the selected target node is a second node.

The provisioning policy allows the specific properties and requirements of the container instance to be started to be taken into account in the distribution process. Because the provisioning policy is associated with the request to start the container instance, it is possible to define and enforce a specific provisioning policy for the container instance. The exchange of load information between the first orchestration unit and at least one other, second orchestration unit of the at least one second cluster, enables efficient and fast communication between the first and the second orchestration units for coordinating the load ratios. Each of the orchestration units knows the utilization of the cluster nodes managed by the orchestration unit or can determine this using existing processes. No additional unit, such as a higher-level coordination unit or orchestration unit, is required to control resource distribution. This means that the solution is also efficient with regard to hardware units for determining the utilization status of the participating clusters. This means that resources can be managed across multiple orchestration units at the same time as accomplishing the actual core tasks of the respective applications running on the cluster.

Shared use of the nodes across multiple clusters is particularly advantageous if, for example, sufficient computing capacity is available within a production line of a manufacturing plant or other Internet of Things (IoT) environments and individual orchestration units can divide up the resources among themselves and dynamically adapt them. In embodiments, the method also allows a fast, gradual use of a new IoT or runtime environment that can be used to start a plant quickly with a small, dedicated setup of the orchestration units and does not require maintenance until all nodes are available. The first cluster cannot contain any nodes, so that the first orchestration unit starts the container instance exclusively on a second node. If there are no resources available on the second node, the container instance will not be run.

In an embodiment, a specific node or node type and/or properties of the node on which the container instance may be started, are specified in the provisioning policy.

This ensures that a container instance that runs an application which, for example, needs to run on a particular device, will run only on that particular device and thus is not started on another first or second node. If a device type is specified in the provisioning policy, the container instance will be restricted to running on a first or second node that matches the specified device type. In an embodiment, in the provisioning policy it is specified whether the container instance may be started only on one of the first nodes or also on one of the second nodes.

This means that starting a security-relevant application or the corresponding container instance, for example, can be restricted to a first node and security requirements for the application can therefore be met.

In an embodiment, a container instance, the execution of which is not limited to a particular node, is started either on one of the first or on one of the second nodes, depending on the first and second utilization status.

This means that any container instances that are not restricted by the provisioning policy to running on first nodes can also run on resources in the second cluster, that is, the second node. This allows a flexible adjustment and maximization of the number of container instances that can be distributed across clusters, allowing a comprehensive distribution across the first nodes and all available second nodes.

In an embodiment, within the first or second cluster a residual capacity of resources for starting container instances is reserved by the orchestration unit of its own cluster, which is not enabled for starting a container instance from the other cluster.

This allows critical, device-dependent container instances to start on a node of their own cluster immediately, rather than waiting for resources to be provisioned in one of the second clusters. In an embodiment, if the container instance is executed by the second node, the first orchestration unit is notified by the second orchestration unit when the second utilization status increases above a specified maximum value, and the execution of the container instance on the second node is terminated.

The container instance is a container instance that was requested in the first cluster, for which a target node in the second cluster was selected and started on one of the second nodes by the second orchestration unit. The utilization status within a second cluster can rise above a maximum value, for example, by individual container instances being more heavily utilized by higher numbers of requests and these themselves requiring more resources, in particular computing capacity and/or storage space on a node, or by a scheduler that automatically restarts further container instances based on an autoscaling policy. This means that resource sharing can be changed even while the container instance is running, and resources can be released on the second cluster.

According to embodiments of the invention, the load information is exchanged via an orchestration interface between the first orchestration unit and the second orchestration unit.

This allows direct communication between the first and second orchestration units. In an orchestration by the orchestration software Kubernetes, the orchestration interface can be implemented, for example, via the interface of an API server, which also accepts orchestration information and requests from local users.

In an embodiment, load information is exchanged via the orchestration interface only after a successful mutual authentication of the first orchestration unit and the second orchestration unit.

This ensures that only trusted second orchestration units are used for resource sharing.

In an embodiment, the load information is exchanged at fixed time intervals or based on a resource allocation event between the first and the second orchestration unit.

This enables continuous or efficient updating of the second utilization status in the first orchestration unit.

In an embodiment, the first orchestration unit receives different authorizations with regard to the configuration of container instances or the resource allocation on the second node depending on the second orchestration unit.

Thus, different second clusters or their second orchestration units can define different conditions for resource allocation by the first orchestration unit. Such authorization can be granted, for example, by an authorization of the first orchestration unit by the second orchestration unit following the authentication.

In an embodiment, the load information is transmitted from the second orchestration unit to a central utilization unit and the load information is queried from the central utilization unit by the first orchestration unit.

This significantly reduces the communication effort, since the first orchestration unit does not have to query the load information directly on every second orchestration unit but achieves this by a single query to the central utilization unit. The same applies to the communication from the second orchestration unit, which must only transmit its load information to the central utilization unit and does not need to respond to every request from different first orchestration units.

In an embodiment, the first orchestration unit is registered with a Publish-Subscribe service as a subscriber and the at least one second orchestration unit is registered as a publisher and the first orchestration unit receives the load information of the second nodes automatically by the Publish-Subscribe service.

The Publish-Subscribe service can be managed centrally or in a decentralized manner. Thus, communication is performed automatically, and the communication modalities can be set, for example, by a communication policy stored on the first and second orchestration units.

In an embodiment, the first orchestration unit transmits the request to start the container instance to the orchestration unit of the selected target node.

A further aspect of embodiments of the invention relates to an assembly for resource sharing in an orchestrated environment comprising a first cluster and at least a second cluster, in which each cluster has at least one node for executing at least one container instance and an orchestration unit for automatically managing the container instances on the at least one node of the cluster, which is designed to:
receive a request to start the container instance, comprising a provisioning policy in a first orchestration unit of the first cluster,
determine a first utilization status of the first nodes of the first cluster for the purpose of providing the container instance by the first orchestration unit of the first cluster,
determine a second utilization status of the second nodes of the at least one second cluster by an exchange of load information between the first orchestration unit and a second orchestration unit of the at least one second cluster,
select a target node from one of the first and second nodes according to the provisioning policy and according to the first utilization status and the second utilization status by the first orchestration unit, and
start the container instance on the target node by the second orchestration unit, if the selected target node is a second node.

This allows resources to be shared across multiple orchestration units within the assembly and thus within the orchestration architecture. For example, if maintenance is performed on a first node, resources can be temporarily relocated to a second node of another, second cluster.

The assembly in that case is configured in such a way that all the features described in the method can be executed by the assembly.

A further aspect of embodiments of the invention relate to a computer program product (non-transitory computer readable storage medium having instructions, which when executed by a processor, perform actions), comprising a non-volatile computer-readable medium which can be loaded directly into a memory of a digital computer, comprising program code parts which when they are executed by the digital computer cause the computer to carry out the steps of the method.

Unless otherwise specified in the description below, the terms “receive”, “determine”, “select”, “start” and the like, refer for example to actions and/or processes and/or processing steps that modify and/or generate data and/or convert the data into other data, wherein the data is or may be in particular in the form of physical quantities, for example electrical pulses. The assembly and, in particular, the physical as well as the virtual realization of nodes, orchestration units and the like therein, can comprise one or more processors.

A computer program product, such as a computer program means, can be provided or supplied, for example, as a storage medium, such as a memory card, USB stick, CD-ROM, DVD, or else in the form of a downloadable file from a server in a network. This may be effected, for example in a wireless communication network, by the transmission of a corresponding file to the computer program or the computer program means.

### BRIEF DESCRIPTION

Some of the embodiments will be described in detail, with references to the following Figures, wherein like designations denote like members, wherein:

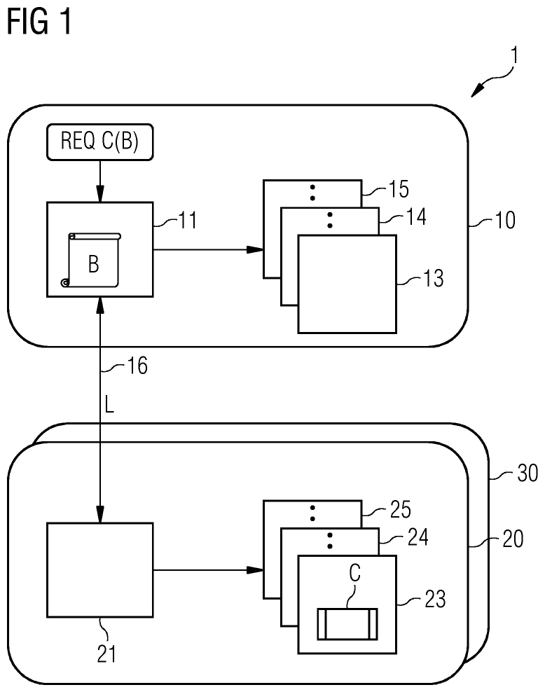

FIG. 1 shows a first exemplary embodiment of the assembly in a schematic representation;

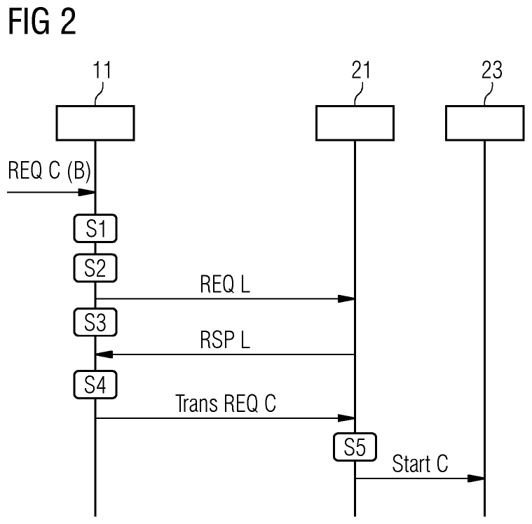

FIG. 2 shows a first exemplary embodiment of the method in the form of a flow diagram;

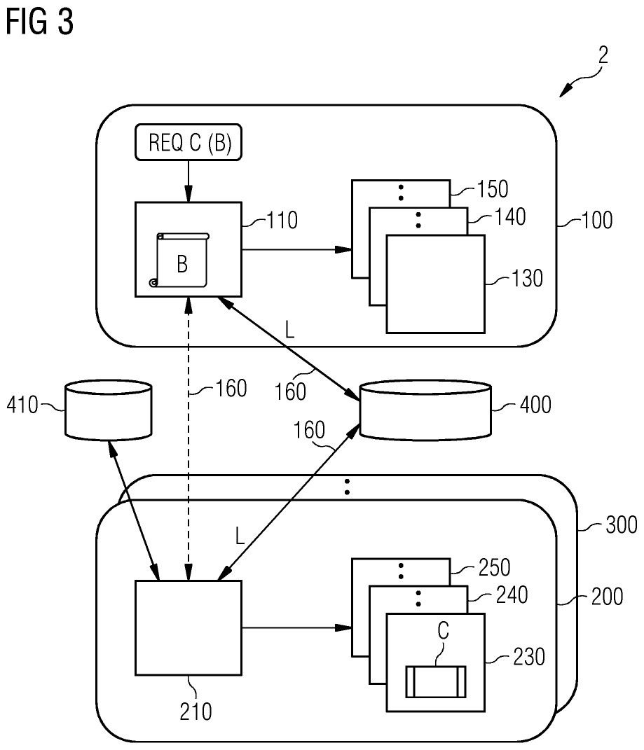

FIG. 3 shows a second exemplary embodiment of the assembly having a central utilization unit in schematic representation; and

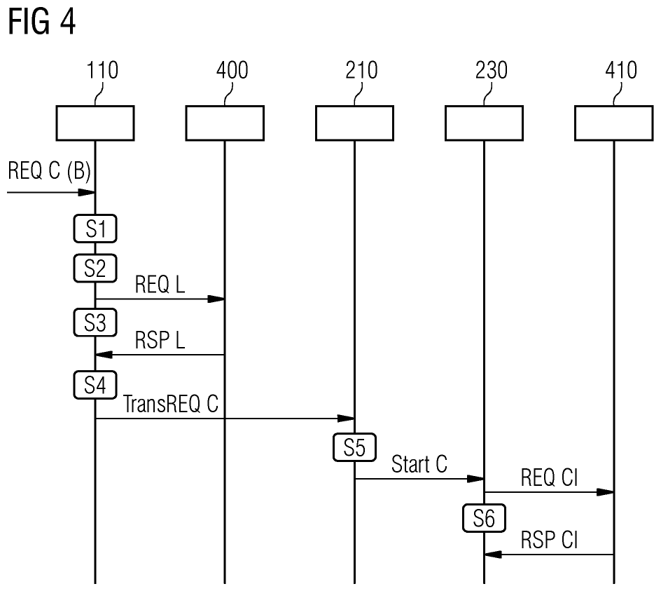

FIG. 4 shows a second exemplary embodiment of the method having a central utilization unit in the form of a flow diagram.

### DETAILED DESCRIPTION

FIG. 1 shows an orchestrated environment with a first cluster 10, and a second cluster 20. The orchestrated environment can comprise additional second clusters, see Cluster 30. The structure of the first cluster 10 and all second clusters 20, 30 and the method steps between the first cluster 10 and all second clusters 20,30 are similar, so that in the rest of the description only the structure and the method steps between the first and second cluster 20 will be described.

The first cluster 10 and the second cluster 20 comprise at least one node (13, 14, 15, 23, 24, 25) for executing at least one container instance, and an orchestration unit (11, 21) for automatically managing the container instances on the at least one node (13, 14, 15, 23, 24, 25) of the cluster (10, 20). A node may be a device, for example a control device or a machine, which may also be implemented virtually and comprises at least one processor.

The orchestrated environment can be, for example, an IoT environment in which different orchestration units, in this case the first orchestration unit 11 and the second orchestration unit 21, control and therefore represent independent production processes and can be independently adapted to suit the product by the respective production managers. Device-non-specific container instances can then be relocated by the orchestration units in such an environment, for example, to the resources, i.e. second nodes of other, second clusters, container instances with higher priority can be executed on self-managed nodes, i.e. first nodes in the first cluster and, if applicable, on specialized hardware, e.g. a control component for an industrial robot.

To be able to manage resources, i.e. first or second nodes 13, 14, 15, 23, 24, 25 or their computing and storage units, for executing container instances across multiple orchestration units 11, 21 and at the same time be able to perform the actual core tasks of the respective applications operated on the cluster, an orchestration interface 16 is formed between the first orchestration unit 11 and the second orchestration unit 21 via which the first orchestration unit 11 and the second orchestration unit 21 exchange load information L in relation to the second nodes 23, 24, 25 in the second cluster 20. This assumes that the first and second orchestration units 11, 21 trust each other and each orchestration unit 11, 21 trusts its managed nodes. The assembly may be a cloud-based system in which the first and second nodes are at least partially arranged in a computer cloud, as well as a so-called “On-premise” system in which the first and second nodes are at least partially arranged “on site”, for example in an industrial plant. The latter is also referred to as an edge cloud.

An allocation of individual container instances to a specific node or node type is specified by a provisioning policy B, which is transferred to the first orchestration unit 11 when a request is made to start a container instance. Container instances that must be started and executed on a specific node or node type are, for example, container instances that require a connection to specific hardware, e.g. programmable logic controllers, or PLC for short. The provisioning policy B thus defines whether the container instance may be executed on any first or second node 13, 14, 15, 23, 24, 25 within the assembly, i.e. the cluster network, whether it is restricted to a device type or a device with specific properties, for example connection to a specific part of the production network, and whether a defined terminal device is provided for the container instance. The provisioning policy B specifies whether the container instance C may be started only on one of the first nodes 13, 14, 15 or also on one of the second nodes 23, 24, 25.

Using FIG. 2, the method steps in the orchestrated environment shown in FIG. 1 will be described in more detail.

In a first method step S1 the first orchestration unit 11 of the first cluster 10 receives a request REQ to start a container instance C. The request does not necessarily have to be received from outside, for example by way of deployment information by the user. It is also possible that a request to start an instance is generated within the first cluster, for example when an overload situation is detected and autoscaling mechanisms in the cluster initiate and thus request a new container instance.

Subsequently, in method step S2, the first orchestration unit 11 of the first cluster 10 determines a first utilization status of the first nodes 13, 14, 15 of the first cluster 10. In addition, see S3, the first orchestration unit 11 determines a second utilization status of the second nodes 23, 24, 25 of the second cluster 20 by an exchange of load information L between the first orchestration unit 11 and a second orchestration unit 21 of the at least one second cluster 20. For this purpose, for example, a request message REQ L is transmitted from the first orchestration unit 11 via the orchestration interface 16, see FIG. 1, to the second orchestration unit 21. This sends the requested load information L with a response message RSP L back to the first orchestration unit 11. If multiple second clusters are present, the second utilization status is determined for each second cluster. In method step S4, the first orchestration unit 11 selects a target node from one of the first and second nodes 13, 14, 15, 23, 24, 25 depending on the provisioning policy specifications, depending on the first utilization status and the second utilization status.

The container instance C is then started on the target node. If a second target node 23 was selected as the target node, the first orchestration unit 11 instructs the second orchestration unit 21 to execute the container instance C. The second container instance 21 then starts, see S5.

For example, the container instance is assigned to the target node in accordance with the authorization policy B using appropriate labels that are given to the container instance or an associated container image.

The first orchestration unit 11 receives different authorizations with regard to the configuration of container instances or the resource allocation on the second node 23 depending on the second orchestration unit 21.

The sequence of execution of the method steps S2, S3, S4 can differ. For example, the first orchestration unit 11 checks the provisioning policy B once it is transferred to the first orchestration unit 11. The first orchestration unit 11 checks whether sufficient resources are available on its own node, i.e. the first nodes 13, 14, 15 and selects the corresponding first node. If the execution of container instance C is not limited by its provisioning policy B to a particular node, container instance C is started either on one of the first nodes 13, 14, 15 or on one of the second nodes 23, 24, 25, depending on the first and second utilization status. Within the first cluster 10 it can optionally be specified that a residual capacity of resources, in particular processor power and memory capacity, must always be kept available for device-specific container instances, or that these should be desired over non-device-specific container instances. Such a residual capacity can be reserved by the second orchestration unit 21 in the same manner and included in the load information L to the first orchestration unit 11.

If the execution of the container instance C is not restricted by the provisioning policy B to a first node 13, 14, 15, this container instance is started on one of the first nodes 13, 14, 15 or on one of the second nodes, depending on the determined utilization status of the individual first and second nodes. The utilization status of the nodes 13, 14, 15, 23, 24, 25 can be determined from load information, which is determined periodically by a scheduler within the orchestration unit 11, 21.

The provisioning policy B can specify that if there is a shortage of resources in the individual cluster, i.e. in the first cluster 10, a container instance of another cluster, for example a container instance that was originally requested in the second cluster 20, is no longer allowed to run on a first node in the first cluster 10, or its execution in the first cluster 10 is stopped. The orchestration unit which manages the node, here the second orchestration unit 21, is informed to that effect by the orchestration unit which requires the node, here the first orchestration unit 11.

Similarly, if the container instance C is executed by the second node 23, the first orchestration unit 11 is notified by the second orchestration unit 21 when the second utilization status rises above a specified maximum value. The execution of the container instance C on the second node 23 is terminated. In order to ensure uninterrupted execution of the container instance C and thus the application thereby provided, the first orchestration unit 11, after receiving this load information, provides a new container instance C on another node and informs the second orchestration unit 21 accordingly. Only on receiving this message does the second orchestration unit 21 terminate the execution of the container instance C on the second node 23. If the container instance C is not relocated from the first orchestration unit 11 in time, the second orchestration unit 21 stops regardless.

In order to prevent or at least impede a query of load information L by unauthorized or manipulated orchestration units 11, 21, the load information is exchanged via the orchestration interface 16 only after a successful mutual authentication of the first orchestration unit 11 and the second orchestration unit 21. The first and second orchestration units 11, 21 authenticate themselves, for example, by a client certificate or a Web token in JavaScript object notation, also known as JSON Web Token. This allows access to a communication network of the second or first cluster 20, 10 to be restricted to known orchestration units 11 or 21.

The load information L is exchanged at fixed time intervals or based on a resource allocation event between the first and the second orchestration unit 11, 21. In one embodiment, the first orchestration unit 11 is registered with a Publish-Subscribe service as a subscriber and the at least one second orchestration unit 21 is registered as a publisher and the first orchestration unit 11 receives the load information L of the second nodes 23, 24, 25 automatically by the Publish-Subscribe service.

As an alternative to an orchestration interface 16 in the form of peer-to-peer communication between the first and second orchestration units 11, 21, the load information L can be exchanged between the first and second orchestration units 11, 21 via a central resource management unit. A corresponding assembly is illustrated in FIG. 3, and the method steps in FIG. 4.

The assembly 2 comprises, according to the assembly 1 of FIG. 1, a first cluster 100 with a first orchestration unit 110 and first nodes 130, 140, 150, and a second cluster 200 with a second orchestration unit 210 and second nodes 230, 240, 250. In addition, the assembly 2 comprises a central utilization unit 400, which receives load information L from the second orchestration unit 210 via an orchestration interface 160 and provides the load information L to the first orchestration unit 110 via an orchestration interface 160. In order to be able to start the container instance C on a target node, in this case for example the second node 230, a corresponding container image CI is provided by a provisioning unit 410, also referred to as an image registry, of the second orchestration unit 210. The orchestration interface 160 is divided into multiple sub-sections if the load information L is provided by the utilization unit 400. In addition to the subsections between the first orchestration unit 110 and the utilization unit 400 and between the second orchestration unit 210 and the utilization unit 400, a further sub-section is present directly between the first and second orchestration units 110, 210, for example, to exchange information for controlling and managing the containers C running on the second nodes 230, 240, 250.

In embodiments, the method steps for receiving the request S1 and determining the first utilization status S2, see FIG. 4, accordingly remain unchanged from the scenario with a direct, peer-to-peer orchestration interface 16. To determine a second utilization status, see S3, the load information L is then queried by the first orchestration unit 110 from the central utilization unit 400. Furthermore, the provision of the container image by the provisioning unit 410 is represented in method step S6.

For the provision of resources or load information L, two different variants are proposed:

A decentralized provisioning variant, see FIGS. 1 and 2, in which the second orchestration unit 11 informs the other participating first orchestration units 21 in the peer-to-peer method, or, for example, using a suitable decentralized Publish-Subscribe service such as a Data Distribution Service (DDS), as to which resources it has available for a requested container instance C in the event of a provision request. The available resources or the load information L can either be queried periodically by the participating orchestration units 11, 21 or actively communicated by the resource-providing second orchestration unit periodically or triggered by an event, such as the desired stoppage of the execution of a container instance C, start of a container instance C, up-scaling and down-scaling of container instances. The behavior can be set in a communication policy stored on the second and/or first orchestration units 11. 21.

In addition, it is possible that in this method a second orchestration unit allows different first orchestration units to have different authorizations regarding the configuration of individual container instances C and permits different resource allocations. For example, the resource-providing second orchestration unit can allocate no resources for privileged container instances or provide different levels of resources for the first orchestration unit 11 according to processor and main memory requirements of different container instances, or depending on the signature of a container, for example, to determine the trustworthiness via its origin. As a further criterion, the first orchestration unit 11 itself can be included, so that different initial orchestration units can be dynamically provided with different resources.

In another variant, it is possible that for the provision of resources of other, second clusters 200 the currently available resources or load information L are entered into a central provisioning unit 400. The provisioning unit 400 can query the second orchestration units 200 independently or be notified by a centrally managed Publish-Subscribe service, such as Message Queuing Telemetry Transport MQTT. The querying or provision of the load information L is carried out e.g. periodically and/or whenever the resource allocation changes due to the starting or stopping of container instances. A combination of both methods is also possible. If a first orchestration unit 110 wants to outsource container instances to a second cluster 200, it can query the resource availability of the individual second clusters 200, 300 if necessary.

In both variants, the requesting first orchestration unit can weight the target or second orchestration unit, and thus control which second orchestration units are desired execution environments for relocated container instances. Criteria for this can be the total available resources or, for example, the latency times of the second orchestration units. Furthermore, the second orchestration unit providing the resources can also provide location information about the second nodes or processor architecture, quality (QoS) requirements such as a real-time capable Linux, etc., which the requesting first orchestration units evaluate. It is also possible that individual clusters charge each other for individual resources used and include these in the weighting.

As soon as a scheduler of the first orchestration unit 110 has determined the target cluster, it transfers the provisioning request, see TransREQ C, for the container instance C to the second orchestration unit 210, see FIG. 4. The issuing first orchestration unit 110 also determines the IP address and informs the receiving second orchestration unit 210 of how an overlay network should be set up. In this case, it is possible that the network is established across the first and second orchestration units or the target node, to which the runtime node, in this case target node 230, selected by the second orchestration unit 210 of the relocated container instance should establish the network connection, is specified. How the network connection is set up is determined in this case by an (overlay) network driver that is used. For example, it is possible for them to set up IPSEC tunnels or a software-designed network (SDN) connection if necessary. The decision as to whether or not further container instances C are to be restarted remains the responsibility of the issuing first orchestration unit 110. However, the receiving second orchestration unit 210 performs a runtime monitoring and reports a status of the container instance C back to the issuing first orchestration unit 110.

The exposure, that is, making the service or application provided in the container instance available for another service or user, by container instances is carried out using load balancers managed by the orchestration units. Here, it is possible for the issuing first orchestration unit 11, 110 itself to orchestrate a load balancer and integrate the relocated container instance C or else to request load balancer functionalities from the receiving second orchestration unit 21, 210. To do this, it must then be integrated into the application network using the overlay network driver, as in the case of the relocation of the container instance.

If distributed data stores or file directories, also called volumes, are required for the container instance C, these must also be provided by the issuing first cluster 10, 100 over the network. Possible examples of these are exposed global file systems, Network File Service (NFS) shares, Web-based Distributed Authoring and Versioning (WebDAV), Internet Small Computer System Interface (iSCSI), and the like. In principle, the technology used to expose a volume is no different from that of a single cluster. However, the services over the network may be further exposed. In our case, they must be exposed or accessible in such a way that the nodes of the receiving second cluster can also access them.

If a second orchestration unit 21, 210 requires space for its own container instances, this can inform the issuing first orchestration unit 11, 110 of its own resource requirements. Depending on defined thresholds, such as a maximum value for processor and memory capacity, this is used to define whether a container instance should be terminated immediately or the first orchestration unit being relocated should first be given the opportunity to start the instance at a different location, such as on its own cluster nodes or another cluster, and to terminate it itself within a specified period. The cluster 10, 20, 100, 200 in which a container instance is to be started, whether on the local first cluster 10, 100 or relocated to a second cluster 20, 200, can be decided by the first orchestration unit 11, 110 depending on the criticality of the container instance C, which is defined, for example, by the author in the provisioning policy B, a defined target platform and the local resource utilization information using a scheduling policy.

In order to be able to run container instances, it is assumed that all the container images CI to be relocated are stored in at least one container image provisioning unit 410, which can be reached from all relevant nodes. In an alternative variant, the receiving second orchestration unit 21, 210 reports back to the issuing first orchestration unit 11, 110 that it cannot obtain the desired container image and then receives it by having it transmitted from the issuing first orchestration unit 11, 110.

In an extended variant, the receiving second orchestration unit 21, 210 can stop container instances of a first orchestration unit 11, 110 if it is performing activities that do not comply with a node policy stored in the second orchestration unit 21, 210. Discrepancies at runtime can be detected, for example, with “Anomaly Detection” mechanisms. The receiving second orchestration unit can refuse to accept container instances of a first orchestration unit if they contradict its own provisioning policies-analogous to Pod Security Policies (see https://kubernetes.io/docs/concepts/policy/pod-security-policy/). Such a pod security policy may be configured differently, for example to be more stringent, for issuing second clusters 20, 200 than for requests to start a container instance of its own orchestration users.

It is conceivable that in a policy it could be defined that a first orchestration unit 11, 21 temporarily relocates to the second nodes of the second cluster 20, 200 only in the event of failure of a first node and for example, uses its own first nodes 13, 14, 15, 130, 140, 150. The described method allows the resources or nodes across multiple clusters to be better used, so that the nodes of the assembly are more evenly utilized. The arrangement according to embodiments of the invention can thus be utilized to a higher overall capacity compared to a conventional orchestrated environment and thus execute more container instances. An orchestration unit can be operated completely without its own nodes or directly orchestrate only system-critical resources or nodes. The solution creates a cloud provider-independent container-as-a-service solution.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for resource sharing in an orchestrated environment having a first cluster and at least one second cluster, in which each cluster has an orchestration unit for automatically managing a container instance on at least one node of the respective cluster, comprising:
receiving a request to start the container instance, including a provisioning policy in a first orchestration unit of the first cluster,
determining a first utilization status of first nodes of the first cluster for the purpose of providing the container instance by the first orchestration unit of the first cluster,
determining a second utilization status of second nodes of the at least one second cluster by an exchange of load information between the first orchestration unit and a second orchestration unit of the at least one second cluster; and
selecting a target node from one of the first and second nodes according to the provisioning policy and according to the first utilization status and the second utilization status by the first orchestration unit; and
starting the container instance on the target node by the second orchestration unit, if the selected target node is a second node, wherein the load information is exchanged via an orchestration interface between the first orchestration unit and the second orchestration unit.

2. The method as claimed in claim 1, wherein a specific node or a node type and/or properties of the node, on which the container instance may be started, are specified in the provisioning policy.

3. The method as claimed in claim, wherein in the provisioning policy it is specified whether the container instance may be started only on one of the first nodes or also on one of the second nodes.

4. The method as claimed in claim 1, wherein a container instance, the execution of which is not limited to a particular node, is started either on one of the first or on one of the second nodes, depending on the first and second utilization status.

5. The method as claimed in claim 1, wherein within the first or second cluster a residual capacity of resources for starting container instances is reserved by the orchestration unit of its own cluster, which is not approved for starting a container instance from the other cluster.

6. The method as claimed in claim 1, wherein if the container instance is executed by the second node, the first orchestration unit is notified by the second orchestration unit when the second utilization status increases above a specified maximum value, and the execution of the container instance on the second node is terminated.

7. The method as claimed in claim 1, wherein load information is exchanged via the orchestration interface only after a successful mutual authentication of the first orchestration unit and the second orchestration unit.

8. The method as claimed in claim 1, wherein the load information is exchanged at fixed time intervals or based on a resource allocation event between the first and the second orchestration unit.

9. The method as claimed in claim 1, wherein the first orchestration unit receives different authorizations with regard to the configuration of container instances or the resource allocation on the second node depending on the second orchestration unit.

10. The method as claimed in claim 1, wherein the load information is transmitted from the second orchestration unit to a central utilization unit and the load information is queried from the central utilization unit by the first orchestration unit.

11. The method as claimed in claim 1, wherein the first orchestration unit is registered with a publish-subscribe service as a subscriber and the at least one second orchestration unit is registered as a publisher and the first orchestration unit receives the load information of the second nodes automatically by the publish-subscribe service.

12. The method as claimed in claim 1, wherein the first orchestration unit transmits the request to start the container instance to the orchestration unit of the selected target node.

13. An assembly for resource sharing in an orchestrated environment having a first cluster and at least one second cluster, in which each cluster has an orchestration unit for automatically managing a container instance on at least one node of the respective cluster, which is configured to:
receive a request to start the container instance including a provisioning policy in a first orchestration unit of the first cluster;
determine a first utilization status of first nodes of the first cluster for the purpose of providing the container instance by the first orchestration unit of the first cluster;
determine a second utilization status of second nodes of the at least one second cluster by an exchange of load information between the first orchestration unit and a second orchestration unit of the at least one second cluster;
select a target node from one of the first and second nodes according to the provisioning policy and according to the first utilization status and the second utilization status by the first orchestration unit; and
start the container instance on the target node by the second orchestration unit, if the selected target node is a second node, wherein
the load information is exchanged via an orchestration interface between the first orchestration unit and the second orchestration unit.

14. A ocmputer program product, comprising a computer readable hardware storage device having computer readable program code stored therein, said program code executable by a processor of a computer system to implement a method, comprising a non-volatile computer-readable medium which can be loaded directly into a memory of the computer system, comprising program code parts which when they are executed by the computer system cause the computer system to carry out the steps of the method as claimed in claim 1.
